(19) United States
(12) Patent Application Publication
(10) Pub. No.: US 2007/0018970 A1
(43) Pub. Date: Jan. 25, 2007

(54) Optical slider for input devices

(75) Inventors: Alain Tabasso, Essertines (CH); Sergio Lazzarotto, Bercher (CH); Patrick Monney, Mex (CH); Daniel Bonanno, Geneve (CH); Nicholas Chauvin, Chexbres (CH); Olivier Mathis, Grimisuat (CH); Florian Kehlstadt, Aclens (CH); Marc A. Bidiville, Monte Carlo (MC); Laurent Plancherel, Lausanne (CH); Jean-Luc Dupraz, Eschandens (CH); Maxime Marini, Geneva (CH)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Logitech Europe S.A., Romanel-sur-Morges (CH)

(21) Appl. No.: 11/418,832

(22) Filed: May 4, 2006

Related U.S. Application Data
(63) Continuation-in-part of application No. 10/025,838, filed on Dec. 18, 2001.
(60) Provisional application No. 60/722,180, filed on Sep. 29, 2005.
(60) Provisional application No. 60/258,133, filed on Dec. 22, 2000.

(51) Int. Cl. G09G 5/00

(52) U.S. Cl. 345/184

(57) ABSTRACT

An optical feedback mechanism corresponding to a variation in input by a user's digit on an input element. The variation in input can be movement by the user's finger, or a change in the amount of pressure or force applied to a button. In one embodiment, the optical feedback is a linear light array adjacent a solid-state scroll/zoom sensor, with the light corresponding to the finger position. Alternately, a solid state button could provide feedback corresponding to the amount of pressure in the form of a change in intensity, color or blinking. In one embodiment, the input signal from an input element alternates between a scroll, zoom and/or other functions depending on the current application.

### CROSS-REFERENCES TO RELATED APPLICATIONS

This patent application is a non-provisional of and claims the benefit of U.S. Provisional Patent Application No. 60/722,180, filed on Sep. 29, 2005, and is a continuation-in-part of U.S. patent application Ser. No. 10/025,838 filed on Dec. 18, 2001, “Pointing Device With Solid State Roller”, all of which are herein incorporated by reference in their entirety for all purposes.

### BACKGROUND OF THE INVENTION

The present invention relates to sensor feedback, in particular optical feedback for scrolling/zooming solid state sensors.

Traditional sensors (toggle switch, press button or potentiometer) have been replaced by solid state (non-moving) sensors in many devices. Examples include force or pressure sensing elements, capacitive sensors and optical sensors. Optical sensors may be buttons, two-dimensional touch screens or one dimensional screens for zooming, etc. Optical touch screens are sometimes used as mouse replacements. Optical touch screens typically have a row and column of LEDs opposed by a row and column of phototransistors for detecting the X-Y coordinates of the finger touching the screen.

US Published Application No. 2004/0046741 of Apple Computer shows an optical-based scrolling device on a mouse. A light emitter (IR LED) reflects light off a window, which can be just about anywhere on the mouse, to one or more photodetectors (four are shown). A tactile feature on the optical touchpad, or a audio device is described for user feedback. Both vertical and horizontal scrolling are described.

http://www.tsitouch.com/touch.php is a manufacturer of optical touch screens and has a description of the working principle on his web site. Another example can be found at http://www.elotouch.com/products/cttec/default.asp.

One example of an optical touch panel patent using modulated light is U.S. Pat. No. 4,893,120. Surrounding the display surface are a multiplicity of light emitting elements and light receiving elements. These elements are located so that the light paths defined by selected pairs of light emitting and light receiving elements cross the display surface and define a grid of intersecting light paths. A scanning circuit sequentially enables selected pairs of the light emitting and light receiving elements, modulating the amplitude of the light emitted in accordance with a predetermined pattern. It describes using several light receivers paired with a single emitter, and vice-versa. Other similar patents on optical touchpads are U.S. Pat. No. 5,162,783, No. 6,495,832 (showing interleaved transmitters and receivers on both sides of opposing rails in one embodiment, to address ambient light interference, No. 6,927,384 (including mention of a single dimension optical touchpad, such as for volume or zoom control, two emitters with one receiver, a high pass filter to remove ambient light), and No. 6,961,051.

An example of an optical cursor control pad, which can be incorporated like a touchpad on a laptop computer, is shown in U.S. Pat. No. 6,872,931. This uses laser diodes and a Doppler effect to track finger motion. Multiple laser diodes can be used for multiple axes of movement, and in one embodiment a single photodetector is used and the laser diodes are alternately activated (col. 15).

U.S. Pat. No. 6,496,180 shows a slider on a mouse, with an LED attached to the slider. The slider is moved past a row of photodetectors, which detect light from the LED to determine the location of the slider.

U.S. Pat. No. 6,552,713 shows an optical cursor control built into a laptop, like a touchpad but with optical detection of finger position for cursor control.

U.S. Pat. No. 6,724,366 shows in FIG. 10A-C an optical switch on a thumb actuated x-y input device. An infrared light beam is broken by a finger in the button depression to activate a switch. This patent goes on two describe using two switches to provide up/down scrolling, in combination with an edge scrolling region on a touchpad.

Other patents relating to optical touch pads include U.S. Pat. No. 4,672,364, No. 4,841,141, No. 4,891,508, No. 4,893,120, No. 4,904,857, No. 4,928,094, No. 5,579,035.

Solid state buttons (usually capacitive) are widely used in lifts and include a visual feedback (sometimes in addition to acoustic). An example of an optical button is shown in U.S. Pat. No. 6,724,366 (FIG. 10). This patent also shows using a focusing lens to concentrate emitted laser beams on a window where a finger will be detected. It also describes up and down movement for scrolling, with sideways movement for a click action.

Solid state sensors have huge advantages over mechanical solutions because of their robustness, protection from external disturbances and contaminations, resistance to wear. Unfortunately their solid nature makes them lack completely user feedback (which is highly appreciated by most users). This feedback is particularly useful when the effects are not noticeable immediately. Pressing a solid state button or adjusting a control without informing the user that her/his action has been taken into account increases the risk to have the user repeat her/his action with in some cases the risk of canceling the original one or overacting.

Some feedback solutions do exist but none of them is perfect. Each one has drawbacks like the beeping noise of some keyboards. Feedback of switches are quite common but in the case of analog controls sounds, which can be annoying, are often used.

When a screen is available (computer, TV) it is easy to display a pop-up and show the current position of the control. But in many cases a screen is not available or a pop-up is unacceptable.

The Apple iPod is an example of a touchpad interface in the shape of a circle. The function of the touchpad varies depending on what module or window of an application the device is in. When a menu is displayed, the touchpad scrolls though the list in the menu. When a song or video is being played, the touchpad controls the volume. This device is described in US Published Applications Nos. 20030076301, 20030076303 and 20030095096.

Immersion Corporation U.S. Pat. No. 6,219,032 shows force feedback to an input device which varies depending on where the cursor is on a screen. Thus, the user will feel a different feedback when the cursor moves across an icon compared to when it is on a scroll bar, for example. U.S. Pat. No. 5,553,225 describes a zoom function for a scroll bar, to allow changing the scroll area.

Interlink Electronics US Published Application No. 20060028454 shows and Apple iPod type circular touchpad, wherein the touchpad performs different functions depending on where on the touchpad the user first puts his/her finger. The functions can include volume, channel selection, frequency, play list selection, stored digital item selection, media play velocity, media play position, moving a cursor, scrolling a list of displayed items, camera position control, pan, tilt, zoom, focus, aperture.

Samsung US Published Application No. 20050199477 describes a scroll key whose function can be selected by a switch, such as selecting between focusing and scrolling through a menu.

Logitech U.S. Pat. No. 6,859,196 describes hand detection in a mouse, using capacitive sensing, to save power.

### BRIEF SUMMARY OF THE INVENTION

The present invention provides optical feedback regarding a variation in input by a user's digit on an input element. The variation in input can be movement by the user's finger, or a change in the amount of pressure or force applied to a button. In one embodiment, the optical feedback is a linear light array adjacent a solid-state scroll/zoom sensor, with the light corresponding to the finger position. Alternately, the slider can be any elongated shape, such as curved, annular, ring shaped, etc. The solid state sensor may be one-dimensional, and could be capacitive, resistive, optical, a mechanical slider, a wheel, or any other input element. A pressure sensitive button where increased pressure corresponds to increased scrolling or zooming could have a single light that changes in brightness or color to give feedback on the amount or speed of scrolling, zooming or other movement. This feedback is especially important for solid state sensors where no tactile feedback is available. Many existing solid state sensors provide an acoustic feedback, which can be disturbing to others and annoying to the user.

In one embodiment, the input signal from the solid state scrolling input alternates between a scroll, zoom and/or other functions depending on the current application. Software in an application, driver, operating system or elsewhere would select how to use the input depending on the application. In one example, if the user is in a photo editing program, the software/driver zooms in and out of the picture when the optical slider or other designated input device is moved. However, if the application is a word processing application, scrolling is automatically activated when the slider is used. Other functions include volume control, such as for a media application, and forward/back for a browser application. In a 3D application, the function could be rotating an object. Where multiple functions are possible for a particular application, a default can be set, which a user can modify according to the user's preferences.

In one embodiment, the invention uses an optical solid state sensor, with at least some of the optical element using visible light so that the same light emitters are used for both sensing and user feedback, reducing power consumption. In other embodiments, the length of the light path is reduced, to limit the power requirements, by either the use of a lens, reflection (rather than transmission breaking) detection, light pipes and geometries which place the emitter close to the detector (such as interleaved emitters and detectors). An interleaved design puts both the emitters and detectors below the optical window, instead of on either side as in the prior art.

In embodiments of the invention used for scrolling/zooming, it has been recognized that the high resolution of prior art touch screens is not needed. Thus, reduced resolution is provided, with a significant reduction in cost and power requirements. A line of less than 20 interleaved emitters and detectors may be used in one embodiment, such as 8 emitters and 8 detectors.

The present invention sensor can be used as a replacement for a potentiometer or any other analog input device with the advantages of a solid state solution but still providing a good visual feedback of the user's actions which is not available with existing solid state solutions. The applications are multiple. For example: all potentiometer applications, a mouse roller, in general all the analog controls that can be added to a mouse, a trackball, a keyboard or any other computer input device. In case very low power is required (battery powered device for example), a presence detector can be used to detect the presence of the user in the close vicinity. Examples of such detectors are PIR sensors, capacitive detectors, and ultrasonic detectors.

Various embodiments of the present invention may be used to implement one-dimensional control (e.g., volume), multi-dimensional control (e.g., scrolling along at least x and y directions), and even ½ dimensional control (e.g., a linear device with some limited movement in the other direction).

### BRIEF DESCRIPTION OF THE DRAWINGS

FIG. 1 is a diagram of a computer system incorporating optical feedback and sensors according to an embodiment of the invention.

FIG. 2 is a diagram of an embodiment of a solid state sensor with parallel optical feedback.

FIG. 3A is a diagram illustrating an embodiment of an optical slider with a single emitter/detector and multiple detectors/emitters.

FIG. 3B is a diagram illustrating an embodiment of an optical slider with multiple detectors and emitters.

FIG. 4 is a flowchart showing the sequence of operations before a finger has been detected in one embodiment.

FIG. 5 is a flowchart showing the operations after a finger has been detected in one embodiment.

FIG. 6 is a diagram of a two-dimensional sensor showing interleaved emitters and detectors according to one embodiment.

FIG. 7A is a diagram of an optical slider embodiment with a linear interleaving of emitters and detectors and a lens bar.

FIG. 7B is a diagram of a cross-section of the diagram of FIG. 7A.

FIG. 7C is a diagram of a baffle for use with the optical slider of FIG. 7A.

FIGS. 8A and 8B illustrate a PCB with emitters and detectors without a baffle (8A) and with a baffle (8B).

FIGS. 9A and 9B are a diagram and cross-sectional view of an embodiment of an optical slider using light pipes.

FIGS. 10A and 10B are a diagram and cross-sectional view of an embodiment of an optical slider using a prism.

FIG. 11 is a diagram of an embodiment of a sensor incorporating a PIR sensor to detect user presence for power savings.

FIGS. 12A and 12B are diagrams of an embodiment of an optical slider incorporating optical buttons before and after adding baffles.

FIG. 13 is a diagram illustrating the function changing driver software according to an embodiment of the invention.

### DETAILED DESCRIPTION OF THE INVENTION

The above application Ser. No. 10/025,838, incorporated by reference, includes the following description of an optical scrolling sensor for a mouse: “In another implementation, the finger rests in a trench wide enough to accommodate the finger, but not too wide in order to guide the finger in the direction of detection. Position detection is achieved with help of an array of light sources, or a single distributed light source, on one of the trench sides, and an array of light detectors located on the other side. Presence of the finger in the trench is detected from the reduced response in the detector directly facing the finger, or from combining responses from all detectors and determining by interpolation its minimum. In another method, the presence of the finger can be determined based on the differences of measured values over time (i.e., when no finger was there). Alternatively, a binary response from the light detector, either absolute (“light is above or below a given threshold, include hysteresis”), or relative with neighboring detector (“light is larger/smaller by a given factor than neighbor, include hysteresis”) can be used. Similarly as in the previous electrode implementation, motion can then be computed based on the “on-off” and “off-on” transition timings with correct relative phase shifts.”

It also states that for feedback for a scrolling motion “lights could flash in the mouse.” Also, “visual feedback is applied by switching on a LED or other light source.”

System

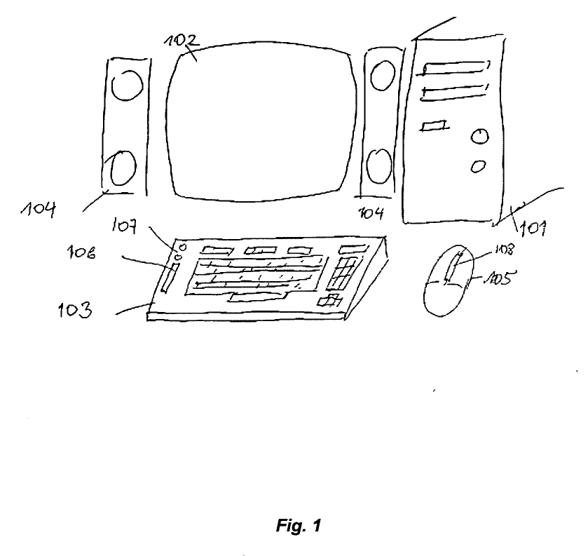

FIG. 1 illustrates one of the applications of the device of the present invention—in a computer system. The system includes a computer 101, a screen 102, a keyboard 103, speakers 104 and a mouse 105. The keyboard includes a linear optical slider 106 that is used to control the volume of the sound from the speakers. On top of this cursor, there are two solid state optical buttons 107. The first one is used as a “mute” control for canceling the sound from the speakers in case of a phone call, for example. The second button is used for music Play/Pause function. The mouse includes another optical slider 108 as a roller replacement.

Optical Feedback

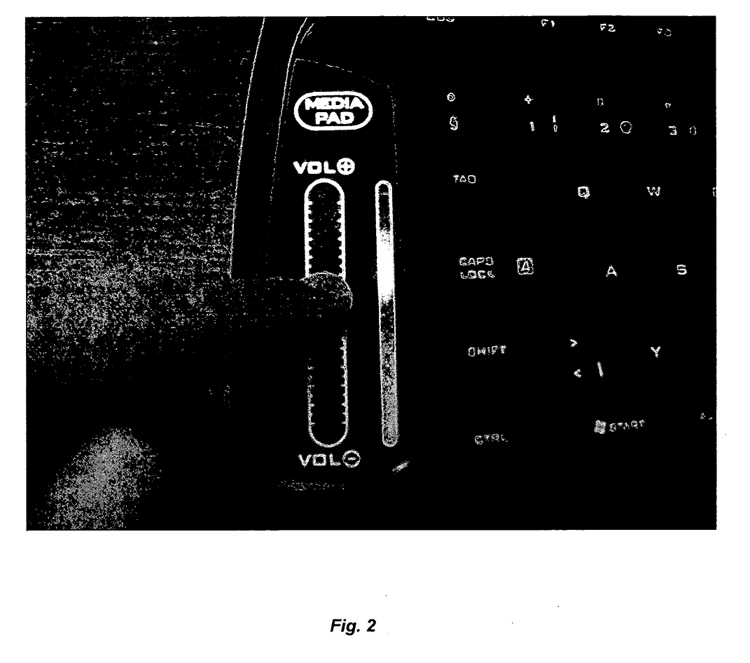

FIG. 2 illustrates a solid state finger position sensor 200 on a keyboard 202. A bar 204 on the right is illuminated at the position of the finger 208 when the finger is detected and a light spot 206 follows the movements of the finger. In the application described in FIG. 1, the sound volume would be increased if the finger is moved up and reduced if the finger is moved down.

The optical feedback corresponds to a variation in input by a user's digit on an input element. The variation in input can be movement by the user's finger, or a change in the amount of pressure or force applied to a button. In one embodiment, the optical feedback is a linear light array adjacent a solid-state scroll/zoom sensor, with the light corresponding to the finger position. Alternately, a solid state button could have an adjacent light source that provides optical feedback corresponding to the amount of pressure in the form of a change in intensity, color or blinking.

The slider could be one or two dimensions, with and adjacent line of LEDs for feedback, or a cross or other shape for two dimensions. The solid state input could be curved or circular. The optical feedback could be LEDs in or at the edges of the solid state sensor itself. This gives optical feedback in the form of light under the finger, so the finger appears to glow as light can be seen through the skin, or light around the edge of the finger. An elongated slider sensor could detect not only position, but pressure, with the optical feedback both tracking the finger position and having varying brightness depending on the pressure.

General Description of the Device:

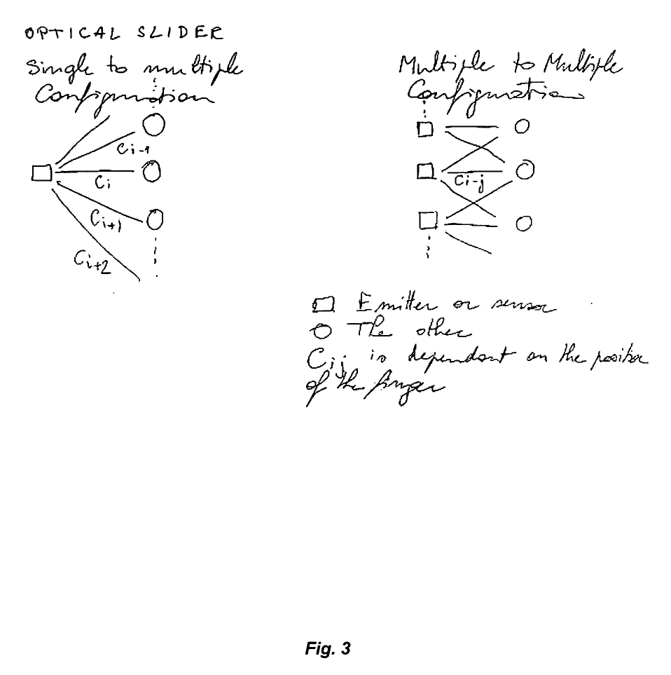

In one embodiment of the present invention, the sensor device is made of a single or multiple elementary opto-electronic component of one type associated with multiple elements of the other type, as illustrated in FIGS. 3A and 3B. An elementary opto-electronic component is an opto-electronic device belonging to one of the two possible types: light emitter (LED) or light sensor (phototransistor, PT or photodiode, PD). Elementary means that it is a small light emitting (or sensing) surface, not multiple surfaces or a large surface area. For example, element 302 in FIG. 3A may be an LED, with photodetectors 304, 306 and 308 all within the range of divergence of the light from LED 302. Alternately, element 302 could be a single photodetector, with elements 304, 306 and 308 being separate LEDs or other photoemitters.

The device is using the physical positions of these components to determine the position of the user's finger on the tracking area of the device by comparing the light transmission coefficients (Cᵢ) between some of the emitter-sensor pairs or by comparing the value of the coefficient of one pair with an earlier value. The device can also provide a visual feedback that shows when the finger is detected, its position and its movements on the sensitive zone.

FIG. 3B illustrates multiple emitters 310, 312 and 314 with multiple photodetectors 316, 318 and 320. In some of the multiple to multiple configurations, one sensor may receive light from more than one LED. The solution to measure independently the contribution of each, is to proceed sequentially. Illuminate one LED, measure its effect (on one or more PT), switch it off, then illuminate another, measure it's effect, etc. This type of algorithm not only identifies independently the effect of each LED, but it also reduces the number of I/O lines required on the microprocessor and also reduces the power requirements of the device.

General Measurement Algorithm:

The mechanical arrangement of the LED and PT defines a certain number of meaningful transmission coefficients among all the possible combinations. In one embodiment, the meaningful coefficients (numbered 0 to n) are identified at the design time and do not change later. The coefficients are the ratios between the LED current and the corresponding photocurrent in the PT; sometimes called CTR (Current Transfer Ratio). “n” is the number of meaningful ones. The meaningful coefficients are those corresponding to LEDs whose light reaches the PT. For example, the 3rd LED is coupled only with the 3rd and 4th PTs (the other coefficients being very close to zero). Theoretically all the meaningful coefficients should be equal (if the arrangement is regular). However, because of real component variations they show small differences. In the microprocessor firmware this can be another physical unit. For example, a unit of time (that is proportional to the inverse of the CTR) depending how the coefficients are measured.

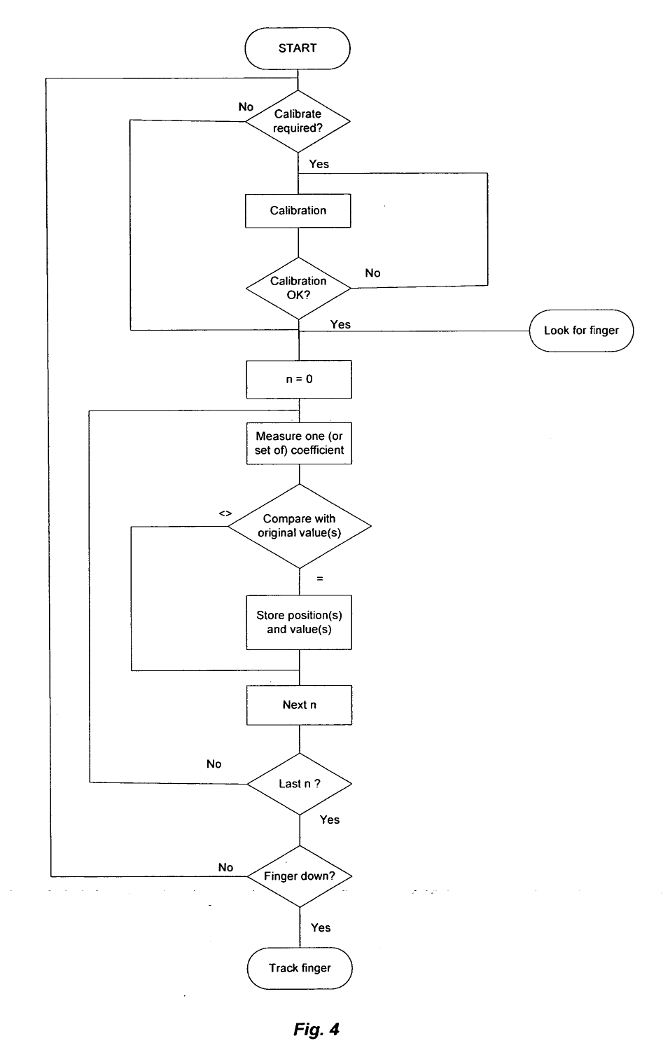

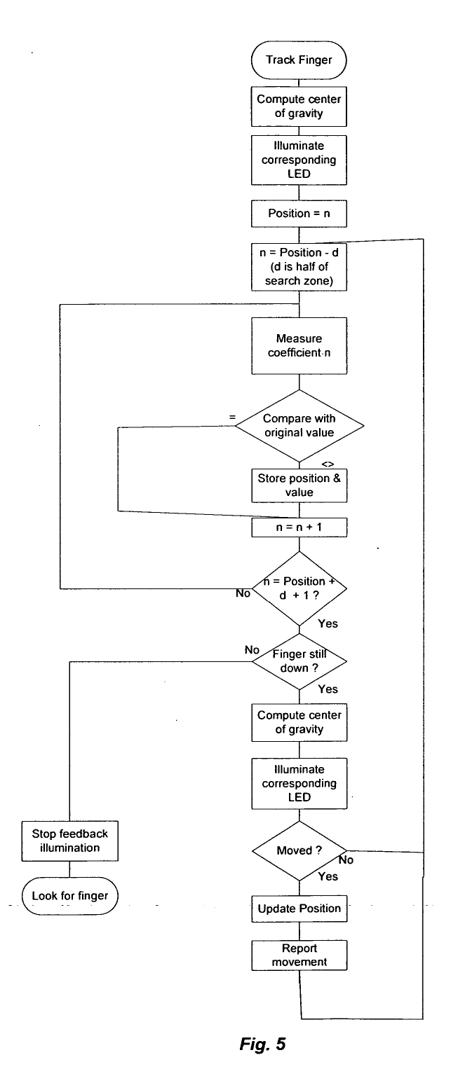

FIG. 4 describes the sequence of operations performed while no finger has been detected. As soon as one is detected, the algorithm changes to the one described in FIG. 5.

In FIG. 4, the sequence of operations is:
1. The sensor is calibrated to take into account the external conditions, components characteristics and to cancel their effects. All the coefficients (signal levels at different detectors) identified as meaningful are measured (without finger) and their values are stored as a reference. In one embodiment, these coefficients are not all the same value because each detector and light path is different due to the individual characteristics of the real components, their assembly and some other possible cause for variation (ambient light, temperature, etc.). Performing such a differential measurement is a well known technique to increase the immunity of a sensor to external variations. It is first determined if calibration is required (step 402), then calibration is done (404) and the calibration is checked to see if it is OK (406). This is followed by a series of steps which is a routine to look for a finger, which is also accessed used from step 524 of FIG. 5.
2. Based on the result of the calibration the tracking algorithm can be adapted to better match the external conditions. This affects how the operations “Measure coefficient n” (410) and “Compare with original value” (412) are performed. These steps are performed after setting n=0 (408). The positions and values are stored (414), and the process is repeated for the next n (416) until all n coefficients have been read (418), or all LEDs have been pulsed for a single detector. The measured values are compared with the original values to determine if there is a variation indicating the presence of a finger (420).
3. The feedback display is OFF as long as no finger is detected. The goal is to detect when and where a finger is present on the sliding surface.
4. In one embodiment, sequentially each LED is illuminated and then each of the related PT(s) is (are) measured. In case there is more than one PT, it is possible to measure one PT after the other or all the ones related to the current LED simultaneously to save time and power.
5. The presence of the finger is detected by the quick change of the value of some (grouped) of these coefficients compared with the reference value. The change can be an increase if the light reflects on the finger or it can be a decrease if the finger cuts or diverts the light traveling from the LED to the sensor.
6. The position of the finger can be computed from the physical position(s) of the coefficients that changed. The algorithm can compute the center of gravity of the finger in case there is more than one coefficient that changed.
7. The feedback display is illuminated in a position matching the detected finger.
8. In one embodiment, from time to time, the initial values (without finger) of the coefficients are updated so that slowly varying parameters like temperature, ambient light, etc. effects are taken into account and their effects canceled.

FIG. 5 describes the sequence of operations after a finger has been detected . . . until it is removed.
1. In one embodiment, once the finger is detected, the group of coefficients that have to be measured can be reduced to those physically close to the finger position (allowing faster scanning of the important ones and/or reducing required power). Thus emitters or detectors not at the finger location, or immediately adjacent, need not be pulsed or read.
2. When a movement is detected, it is reported to the controlled system (or to the host computer).
3. When a movement is detected, the feedback display is updated accordingly.
4. If applicable, the group of measured coefficients is continuously adapted when movements are detected.

As shown in FIG. 5, once the finger has been detected with the sequence of FIG. 4, the center of gravity of the finger is calculated (502). An LED adjacent the finger position is illuminated to provide user feedback (504). The position of the center of gravity, n, is indicated (506). A search area is then established with a search zone of d on either side of the position n (508). The coefficient is measured for each LED/detector pair in the search area (510) and is compared to the original value to determine if the finger is there, or how much of the finger is there (512). The position and value are stored (514) and the next LED/detector is set to be examined (516) until the range has been covered (518).

If the finger is no longer down (520), the feedback illumination is stopped (522) and the process of looking for the finger in FIG. 4 is resumed (524). If the finger is still down, the center of gravity is computed again (526), with the corresponding feedback LED being illuminated (528) and a determination is made if the finger has moved (530). If the finger has moved, the position is updated (532), the movement is reported (534), and the LEDs/detectors in the search zone are monitored again.

An algorithm in accordance with an embodiment of the present invention, to perform measurement of one (or more) coefficient(s) is outlined below:
1. Switch all LED OFF.
2. Initialize A/D conversion(s).
3. Wait for conversion time.
4. Read “Dark” value(s) from the A/D converter(s).
5. Illuminate one LED.
6. Initialize A/D conversion(s).
7. Wait for conversion time.
8. Read the “Light” value from the A/D converter.
9. Switch the LED OFF.
10. Combine “Dark” and “Light” values into a unique number.

Instead of measuring one single “dark” and one single “light” pair of values, it is possible to measure few (or all) the values related to one LED simultaneously.

An alternate measurement method requiring no A/D converter is outlined below:
1. Switch all LEDs OFF.
2. Clamp all the PT to be measured (=discharge internal capacitor).
3. Release PT clamping (allows the output of the PT to change if it gets light).
4. Measure the time required by each PT to reach the switching threshold of the uP input it is connected to (without LED illumination, through the effect of ambient light). Can be long, resulting in counter overflow.
5. Clamp again all the photo-transistors to be measured.
6. Release PT clamping.
7. Switch one LED ON.
8. Measure the time required by each PT to reach the switching threshold of the uP input it is connected to. The time is inversely proportional to the photocurrent.
9. Combine “Dark” and “Light” values into a unique number.

The two compensation methods described above (initial value and dark value) are slightly different and can be used alone or in combination. They have slightly different features. For example if there is a high level of ambient light, the initial value will measure higher transmission coefficient values on ALL coefficients. On the contrary, the “dark” measurement will find significantly lower values near the finger because the finger will prevent ambient light to reach the corresponding PT. The level of performance of the product can be increased by selecting the optimum algorithm (or combination) depending on the conditions. For example, when ambient light is low or medium, the reflection of the light on the finger surface can be used, and when ambient light is very high, the shadow of the finger without even illuminating the LEDs can be used.

In one embodiment, the level of ambient light is monitored by tracking the signal outputs of the photo-detectors. The algorithm used is switched, as described in the above paragraph, depending on the level of ambient light detected.

In the path between the emitter and the sensor, the light travels through a transmission path. This path can be made in many different ways from very simple to quite complex. The transmission path and the positions of the elementary opto electronic components will affect:
The precision of the detection
The power requirement
The cost of the required components
The sensitivity to ambient light
   Extension to 2D.

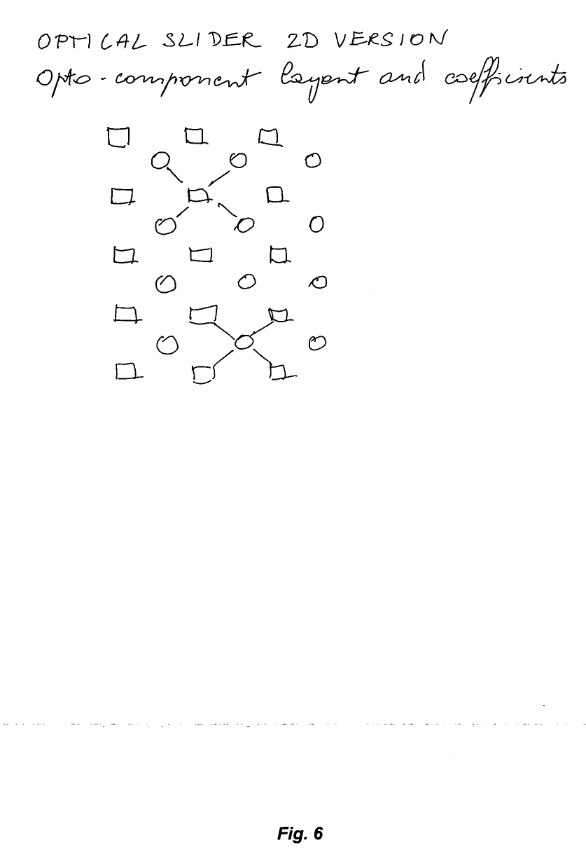

In some embodiments of the present invention, the device is extended to a multi-dimensional device. FIG. 6 shows an example how this could be done for 2D. The proposed pattern for opto-electronic components above is one possibility (only some of the meaningful coefficients are shown). This time, one LED (602, 604) is related with 4 PT, resulting in 4 coefficients, each one corresponding with four possible finger positions around the LED. LED 602 is surrounded by 4 PTs 606, 608, 610 and 612. LED 604 is surrounded by PTs 614, 616, 618 and 620. These structure is used where light is projected upward from beneath the touch area, and a reflection is detected by the photo-detectors. Here also, interpolation can help increase the resolution. In this configuration, if visible feedback is required, using visible LEDs for measurements makes things simpler. The user would see the LEDs underneath and optionally around the finger light up. This works well with only activating the LEDs near the finger to save power, with the LEDs doing double duty of detection and user feedback. An alternative if IR LEDs are used is to use one row of visible LEDs at the top of the matrix and one column on a side. The LEDs on the edges could light up at the column and row position of the finger. Alternately, visible LEDs could be intermixed with infrared LEDs in the array.

Some advantages of a device in accordance with embodiments of the present invention:
1. Lower cost than capacitive pad.
2. Visual feedback for both the finger detection and the position.
3. Requires much less processing power than a capacitive sensor.
4. Allows completely sealed front panel. A plus for ESD (Electro Static Discharge) and dirt contamination.

Specific configurations in accordance of various embodiments of the present invention are described below.

Optical Slider with Linear Interleaving of Emitters and Detectors

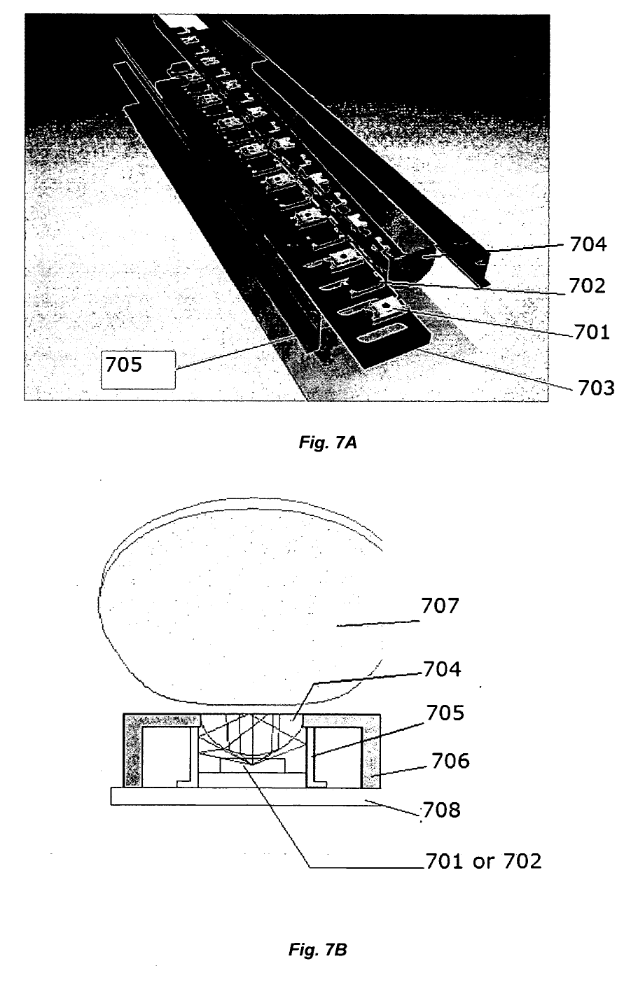

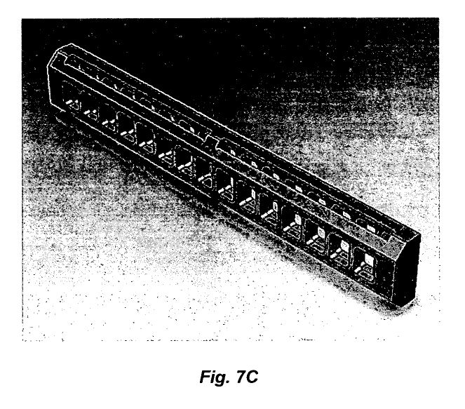

FIG. 7A is a diagram of an optical slider embodiment with a linear interleaving of emitters and detectors and a lens bar. LEDs (701, clear) are interleaved with Phototransistors (702, dark). Each opto component transfers light with its two neighbors. This allows for double the resolution with the same number of components. A baffle (703) prevents the light from traveling directly from LED to PT (Photo Transistors). Lens bar (704) accomplishes two functions: (1) Its curved lower side concentrates the light IN and OUT of the bar towards the opto component. (2) The upper side lets the light out (and in when a finger is pressed against it) allowing detection of its presence and its position.

In case the finger is more than one pitch unit large, it is possible to determine the position of its center of gravity. It is also possible to interpolate the position of the finger on the scale by comparing the transmission factor between one opto-electronic component and its two neighbors. Lateral reflectors (705) redirect the oblique rays towards the upper side of the lens in order to increase the efficiency. The resolution (without interpolation) is equal to the pitch of the opto-electronic components. The finger position is measured by shining sequentially the LEDs and measuring for each one the amount of light on the two associated PhotoTransistors (PT).

The PT can be replaced by other light sensors, for example PD (Photo Diode) without changing the working principle.

FIG. 7B depicts a vertical cut of the device in FIG. 7A with some light rays shown. Device enclosure (706) shields the device from the ambient light. User finger (707) is in contact with the upper part of the cylindrical lens. The PCB (708) makes all electrical connections and also aligns the opto-electronic components mechanically.

Many variants are possible. FIG. 7C shows a baffle 710 which realizes two functions. The lower part (712, in the back on the figure) looks like a ladder and the “steps” are vertical walls that prevent the light from the LEDs reaching directly the Photo-transistors. The upper part 714 also has a ladder shape but it is offset by half the opto-electronic component pitch from the bottom ladder. The walls, in combination with those of the lower level, cut the rays that are not at an angle close to 45 degrees (the ones that are used by the detection system). The result is that useless rays either from the LED or from the ambiance are cut off.

Another variant uses no lens. In case a low profile is desired, the thickness of the lens is a limitation. It is possible to suppress it especially when an improved baffle similar to the one above is used. In this case, the current in the LEDs should also be increased to compensate for the lower efficiency. Only a transparent layer at the top of the system protects the sensor and provides a smooth sliding surface for the finger.

Baffle for Optical Slider

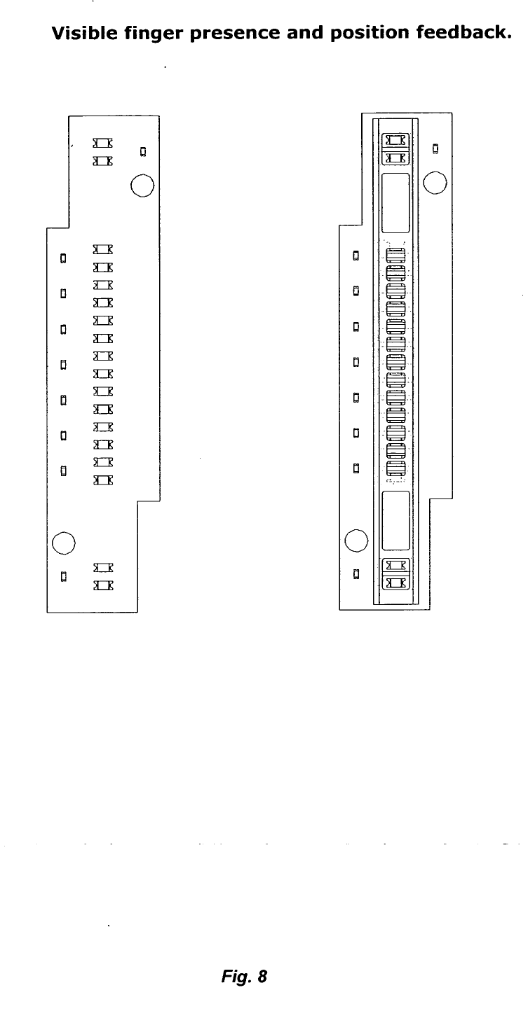

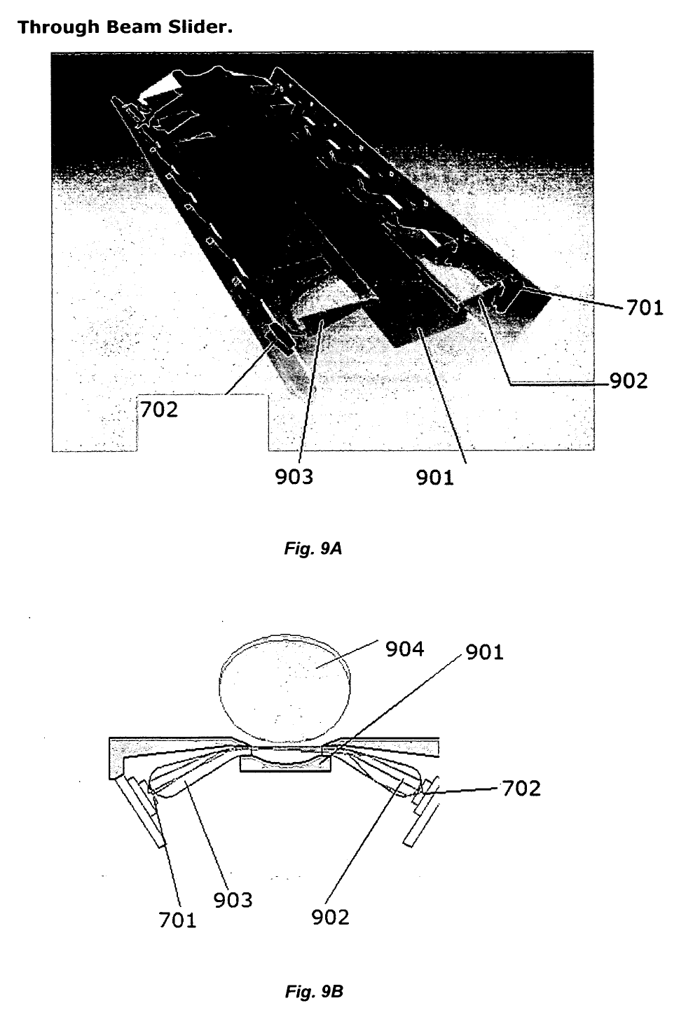

FIGS. 8A and 8B illustrate a PCB with emitters and detectors without a baffle (8A) and with a baffle (8B). The row 802 in the center is a sequence of LED, PT, LED, . . . that is used as a linear cursor (13 positions without interpolation). The seven small components 804 on the left of the cursor row are visible LEDs used for position feedback. The two pairs 806, 808 (one above and one below the cursor) are optical buttons as described below in relation with FIG. 9. Visible feedback LEDs 810, 812 are associated with these buttons. The feedback LEDs can be placed on one side of the row or on the other, if possible in a place that will not be hidden by the user's finger. In one embodiment, when separate feedback LEDs are used, InfraRed LED and PT are preferred, taking advantage of the filtering capability of the PT package to reduce the effects of ambient light.

A visible feedback is also possible by using visible LEDs for illumination. But this has some drawbacks. The illuminating LEDs are hidden by the finger, making it necessary to shine also the neighbor LEDs. The photosensors cannot use a black color plastic packaging that is transparent only to IR (Infra Red) and filter out visible light. They will then be also sensitive to visible light, making them more prone to disturbances from the ambient light. The main advantage is the cost reduction resulting from a reduced number of components. Size is also reduced. FIG. 8B adds a baffle 814.

Optical Slider with Light Pipes

FIGS. 9A and 9B are a diagram and cross-sectional view of an embodiment of an optical slider using light pipes. Light from the LEDs (701) is collected by light pipes (902) and driven to one side of the grooved finger guide (901), parallel and slightly above the surface. On the other side of the groove, similar light pipes (903) collect the light and direct it to the PhotoTransistor (702). When a finger sits in the groove, the light transmission is reduced (or cut) and the position of the interrupted LED/PT pair(s) corresponds to the position of the finger. The LED row and the PT row are offset by half of their pitch. This allows one LED to illuminate two PTs, then doubling the resolution. In this configuration, the center of gravity and the interpolation methods are also possible to increase the resolution. Without interpolation, the resolution is half the pitch of the LEDs (or of the PTs). In one embodiment, detection is also performed by shining sequentially the LEDs and measuring corresponding PT currents.

Optical Slider with a Prism

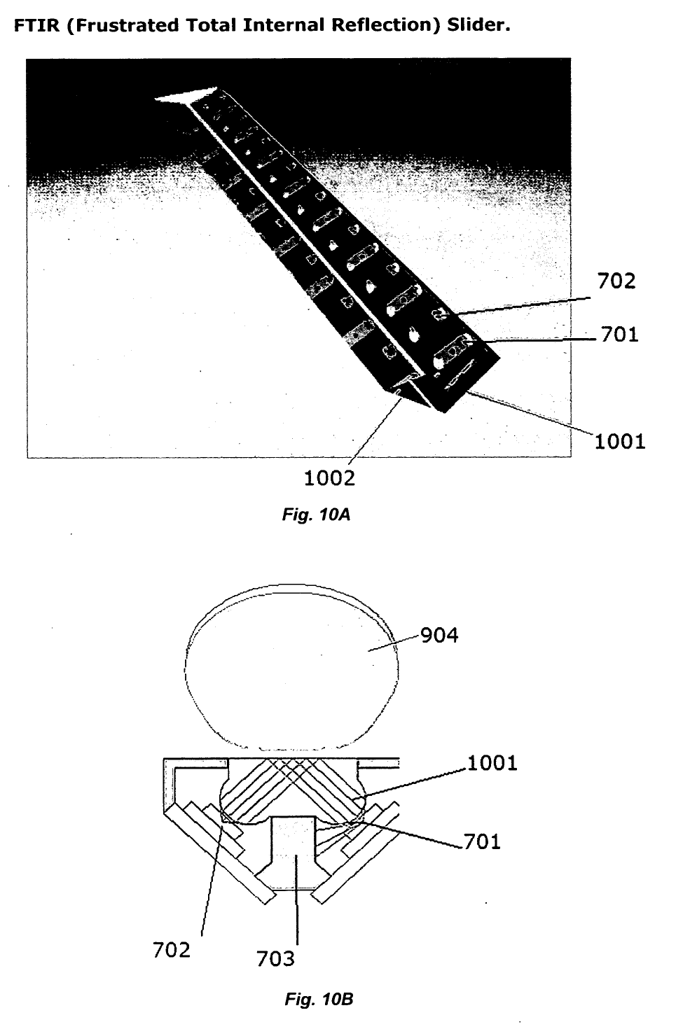

FIGS. 10A and 10B are a diagram and cross-sectional view of an embodiment of an optical slider using a prism. In one embodiment, light from the LED (701) enters the prism on one of its small sides (1001). Then it hits the top side of the prism with an angle of less than 42 degrees (or the limit refraction angle for the material used for the prism, 42 degrees corresponds to a material with 1.5 refraction index). If no finger is present, most of the light is reflected and then hits second small side (1002) of the prism that is mirror coated. It is then reflected and hits again the top surface of the prism where it is also reflected to finally reach the two PTs next to the emitting LED, one on each side). Detection may also be performed by shining sequentially the LEDs and measuring corresponding PT currents.

FIG. 10B shows a vertical cut of the device with some light rays shown. The configuration is slightly different from above. LED (701) and PT (702) are on both sides of the prism. There is no mirrored surface on the prism (1001). The light travels only once through the prism. Entrance and exit surfaces of the prism have a lens shape in front of each of the opto components to better concentrate the light and increase the efficiency. Baffle (703) prevents direct transmission of light form the LED to the PT. The drawback of this configuration compared with the one above is that two separate PCB (Printed Circuit Boards) are required.

More Variants in Implementation.

The PCBs shown above are of rigid type. It is possible to use flexible ones and make the curve of the slider match the external shape of the product (a mouse for example).

In some configurations, the finger does allow an increase of the light transmission between the facing LED and the PT. In other cases, it can block this transmission. All depends on the mechanical construction of the device. It is even possible to combine both, having reflection on the edge of the finger with the finger preventing any light reaching the sensor right below it. This would be a way to reduce the sensitivity of the device to ambient light.

It is possible to use the same set of LEDs for illumination and for detection (cost and size reduction). In this case, they have to be visible light (no IR). The finger tracking algorithm may need to be changed accordingly. In one embodiment, a quick and low frequency scan of the full length is performed when no finger has been detected. In one embodiment, once the finger is detected, only the LEDs that are close will be scanned, very frequently and with high intensity, adjusting which LEDs are illuminated when a finger movement is detected.

For the examples above, the sensitive area is linear, mimicking a linear potentiometer. In an alternate embodiment, the LEDs and sensors are arranged in different shapes, e.g., a circle shape, mimicking a circular potentiometer or a rotative control.

Power Savings with PIR Sensor

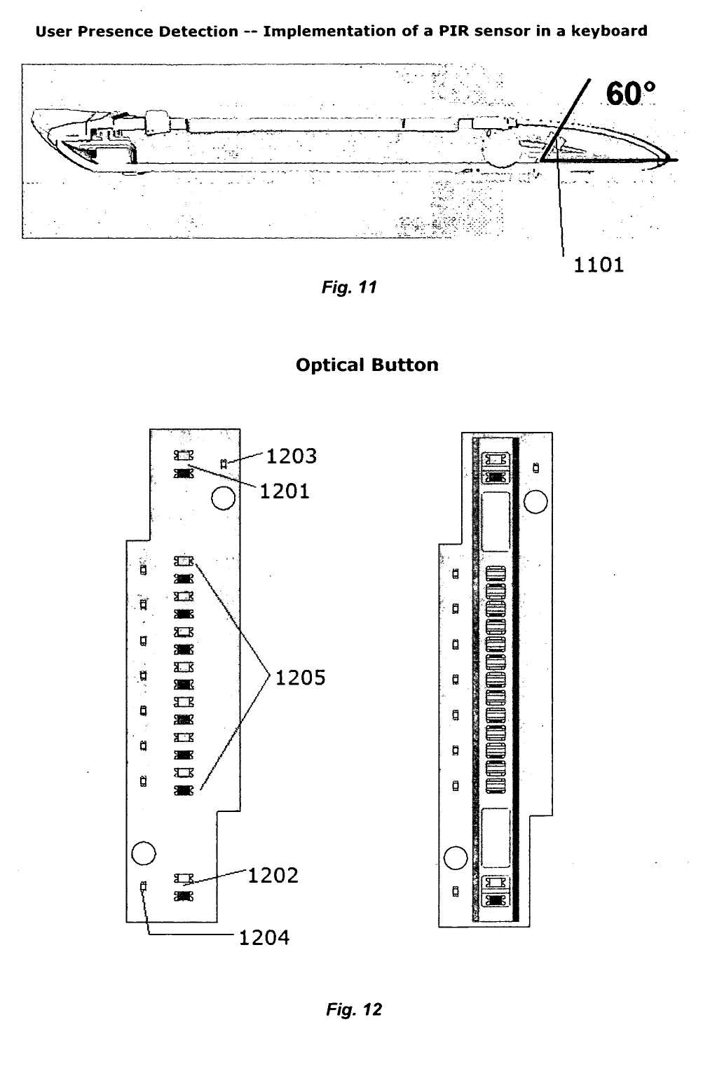

FIG. 11 is a diagram of an embodiment of a sensor incorporating a PIR sensor 1101 to detect user presence for power savings. On battery powered devices, it is important to save as much power as possible. In one embodiment, after some time of inactivity (no finger on the sensitive area), the device can reduce the sampling frequency. This can be done in steps, reducing sampling one step at a time until a very slow frequency is reached. In one embodiment, this may delay the reaction of the device the first time it is used after a long period of inactivity, in the morning for example. But, after that, reaction will be immediate. In one embodiment, to reduce the power consumption further, a PIR sensor 1101 is included in the device, similar to those used in automatic lighting systems. This would allow stopping the sampling completely, but at the cost of the power for the PIR sensor itself and control electronics.

Optical Slider with Optical Buttons

FIG. 12 illustrates one embodiment including optical buttons. This is a version of the same implementation as FIG. 8. The two optical buttons (1201, 1202, one above and one below the slider 1205) are made of one IR LED, one IR PT and one visible LED (1203, 1204). The button is simply one “slice” of the slider structure (one LED and one PT). In one embodiment, only the presence of the finger is detected, but its position/movement is not detected.

In one embodiment, simple switches are used in conjunction with an optical slider, and are used to control other functions in relation with the optical slider. Example: slider=volume, switches=mute, play, pause, next, previous, etc. In one embodiment, the detection will not be realized with a mechanical switch but with optical reflex sensors associated with a feedback LED.

Automatic Switching Between Functions

In one embodiment, the input signal from the solid state scrolling input alternates between a scroll and a zoom function depending on the current application. Software, firmware or hardware would select how to use the input depending on the application. In one example, if the user is in a photo editing program, the software/driver zooms in and out of the picture when the optical slider or other designated input device is moved. However, if the application is a word processing application, scrolling is automatically activated when the slider is used. Other functions include volume control, such as for a media application, and forward/back for a browser application. In a 3D application, the function could be rotating an object. Other functions could include channel selection, contrast, frequency, media play velocity (ranging from slow motion to fast forward), media play position, moving a cursor, and camera position control or image control including pan, tilt, zoom, focus and aperture.

The function can also be varied depending on where in a particular program the user is, or where on a screen the user is. In one example, if the user has a picture on the screen the software/driver zooms when the optical slider is used. However, if the cursor is in text, such as a Word document or text in another application, scrolling is automatically activated when the slider is used. In one embodiment, the user could move the finger horizontally, or touch a button adjacent to the slider, to switch between zoom and scroll. This might be useful where a user might want to override the automatic determination, and scroll down a large picture rather than zoom in or out. This action could either override the automatic determination, or be in place of the automatic determination. The same could apply to a pressure sensitive button used for scrolling/zooming or other functions.

FIG. 13 illustrates one embodiment for controlling the function of a slider 1302 on a keyboard 1304. In one embodiment, the software for controlling the function of the slider is in a driver 1306 loaded onto the computer 1308. Also, the software can function for other input devices, such as a mechanical roller, joystick, touchpad, trackball, etc. The driver could be loaded by any method, such as by a CD, downloaded over a network, or transferred from a memory in the input device. The software includes a program detection module 1310 which will capture messages from the operating system that indicate when a switch between programs is being performed, and change the function according to the program. Multiple programs can be active at the same time, and the software detects which is displayed in the active window. Where multiple windows are displayed, the software detects which window the cursor is in. The software includes a function select module 1312 which accesses a table 1314 which lists various programs or program types, with an associated input function for the slider or other input device.

In one embodiment, default settings are stored in table 1314 for each program or program type, and the user can change the default settings according to the user's preferences. For example, the user could select the default to be scrolling in a photo editing program, rather than zooming. The changing of the default can also change the other function that is switched to based on another input from the user. This additional input could be another switch or button to change the functionality, horizontal movement, touching a particular area of a slider or touchpad, etc. Thus, the invention can combine automatic function selection based on application with user selection ability within that application.

As will be understood by those of skill in the art, the present invention may be embodied in other specific forms without departing from the essential characteristics thereof. For example, the solid state sensor could be arranged in a circle or other shape, and the optical feedback element need not have the same shape. For example, a point light source varying in intensity or color could be used for visual feedback of an elongated optical slider. Alternately, a button or any other input element could be used, with the detection of the software program in use changing the function of the button. In one embodiment, the button provides an analog input similar to a slider or touchpad, such as by using a pressure sensitive button. Accordingly, the foregoing description is intended to be illustrative, but not limiting, of the scope of the invention which is set forth in the following claims.

What is claimed is:

1. A user input device comprising:
a sensor for tracking a variation in input by a digit of a user;
a light emitter for providing a feedback signal corresponding to said variation by said digit of said user.

2. The device of claim 1 wherein said variation is a movement of said digit along said sensor, said sensor being elongated.

3. The device of claim 2 wherein said elongated sensor is curved.

4. The detector of claim 3 wherein said elongated sensor is in the shape of a circle.

5. The device of claim 1 wherein said variation is a variation in pressure applied to said sensor.

6. The device of claim 1 wherein said sensor is an elongated sensor for controlling scrolling/zooming of a computer display.

7. The device of claim 6 wherein said light emitter comprises an elongated strip of light emitters, parallel to said elongated sensor, which is configured to illuminate at a position corresponding to a position of said digit of said user.

8. The device of claim 1 wherein said sensor is a solid state sensor.

9. The device of claim 8 wherein said sensor is an optical sensor.

10. The device of claim 9 further comprising;
a photo-detector; and
a lens for focusing reflected light from a finger onto said photo-detector.

11. The device of claim 7 further comprising a plurality of photo-detectors offset in pitch from a sensor light emitter.

12. The device of claim 1 wherein said light emitter is part of an optical sensor, providing the dual functions of sensing and user feedback.

13. The device of claim 1 further comprising:
a PIR sensor configured to detect a user's hand; and
power control circuitry configured to limit power in said device in response to the absence of detection of a user's hand for a predefined period of time.

14. A user input device comprising:
an optical window;
a plurality of light emitters mounted inside said optical window and oriented toward said window to direct light at said window;
a plurality of photodetectors mounted in interleaved fashion between said light emitters, to detect light reflected in from said optical window.

15. The input device of claim 14 wherein said light emitters and photo detectors are mounted in a line, with less than 20 total light emitters and photodetectors.

16. The input device of claim 15 further comprising first and second optical buttons at the ends of said line.

17. The input device of claim 14 wherein said light emitters and photodetectors are mounted in a two dimensional interleaved array.

18. The input device of claim 14 further comprising a lens bar between said window and said light emitters and photodetectors.

19. The input device of claim 14 further comprising a baffle providing a barrier between said light emitters and photodetectors to reduce light directly reaching said photodetectors from said light emitters without being reflected off said window.

20. The input device of claim 14 further comprising at least one light pipe directing light from said light emitter toward said window.

21. The input device of claim 14 wherein said input device is a keyboard, and wherein said light emitters are infrared LEDs.

22. The input device of claim 14 wherein said input device is a mouse, and wherein said light emitters are infrared LEDs.

23. A user input device comprising:
an elongated sensor for tracking a movement of a digit of a user along said sensor to control scrolling/zooming of a computer display;
an elongated strip of light emitters, parallel to said elongated sensor, which is configured to illuminate at a position corresponding to a position of said digit of said user to provide a feedback signal corresponding to said movement by said digit of said user.

24. A method for providing feedback corresponding to a user input on a user input device, comprising:
tracking a variation in input by a digit of a user; and
providing an optical feedback signal on said user input device which varies to said variation by said digit of said user.

25. A user input system comprising:
a sensor for tracking a variation in input by a digit of a user;
computer readable media containing program instructions for detecting a software program being used by said user; and
said computer readable media further containing program instructions to make a selection of a function in said software program to be controlled by said sensor.

26. The system of claim 25 wherein said function is further based on the current content of said software application.

27. An input system for an electronic appliance comprising:
an input element; and
a module for detection of a software program in use, said module automatically selecting a function for said input element in said software program.

28. The input system of claim 27 wherein said input element is an analog input.

29. The input system of claim 27 wherein said input element is one of a slider, touchpad, roller, joystick trackball, and pressure sensitive button.

30. The input system of claim 27 wherein said module stores a user selected preference for said function.

31. The input system of claim 27 wherein said module is further configured to determine a location of a cursor in said software program and vary said function in accordance with said location.

32. The input system of claim 27 wherein said function includes one of scrolling and zooming.

33. A method for providing an input to an electronic appliance, comprising:
providing an input signal from an input element; and
detecting a software program in use;
automatically selecting a function for said input signal in said software program.

34. The method of claim 33 further comprising storing a user selected preference for said function.

35. The method of claim 33 further comprising:
determining a location of a cursor in said software program; and
varying said function in accordance with said location.
